(19) United States
(12) Patent Application Publication
(10) Pub. No.: US 2010/0095474 A1
(43) Pub. Date: Apr. 22, 2010

(54) HOSE FOR A SURFACE TREATING APPLIANCE

(75) Inventor: Neil Andrew Stewart, Malmesbury (GB)

Correspondence Address: MORRISON & FOERSTER LLP, 1650 TYSONS BOULEVARD, SUITE 400, MCLEAN, VA, 22102, US

(73) Assignee: Dyson Technology Limited, Malmesbury (GB)

(21) Appl. No.: 12/520,474

(22) PCT Filed: Nov. 29, 2007
(86) PCT No.: PCT/GB2007/004572

§ 371 Date: Jul. 31, 2009

(30) Foreign Application Priority Data
Dec. 22, 2006 (GB) 0625806.5

(51) Int. Cl. A47L 9/00; F16L 11/12; F16L 9/18

(52) U.S. Cl. 15/300.1; 174/47; 138/111

(57) ABSTRACT

A vacuum cleaner has a hose and wand assembly, onto which a floor tool may be attached. Power and signals are transmitted down electrical conductors in the hose. In order to permit free movement of the hose, the hose is divided into portions having a joint therebetween. Conductors of one hose portion terminate in contact anus in the joint. The contact arms are in sliding intimate contact with slip rings. The slip rings are connected to conductors of the other hose portion. Thus, the hose portions may rotate relative to one another without causing damage to the electrical connection along the hose.

### REFERENCE TO RELATED APPLICATIONS

This application is the national stage under 35 USC 371 of International Application No. PCT/GB2007/004572, filed Nov. 29, 2007, which claims the priority of United Kingdom Application No. 0625806.5, filed Dec. 22, 2006, the entire contents of both of which prior applications are incorporated herein by reference.

### FIELD OF THE INVENTION

The invention relates to a hose for a surface treating appliance, such as a vacuum cleaner.

### BACKGROUND OF THE INVENTION

Vacuum cleaners are typically of the upright or cylinder type. Cylinder cleaners consist of a main body containing a motor and fan unit for drawing an airflow into the main body and separating apparatus for extracting dirt and dust from the airflow and retaining it for disposal. The separating apparatus can be a cyclonic arrangement, bags, filters or a combination of these. A hose and wand assembly is connected to the inlet of the main body. A floor tool having a suction opening is attached to the end of the wand remote from the main body so that the suction opening can be manoeuvred across the surface to be cleaned by the user. Upright cleaners commonly have a cleaner head permanently attached to the main body of the vacuum cleaner which is manoeuvred, together with the main body, across the surface to be cleaned. However, many upright cleaners can also be operated in the manner of a cylinder machine by having a removable or releasable hose and wand assembly provided to which an accessory such as a floor tool can be attached.

Conventional floor tools typically comprise a housing which defines a downward-facing suction opening and in which is arranged a driven agitator in the form of a brush bar or beater, for example. Dirt and dust is dislodged from the carpet or other floor covering by the rotating brush bar or beater and the dirt and dust is drawn into the cleaner head by virtue of the suction produced by the downstream fan. Dirt laden air is then passed to the separation apparatus before clean air is expelled to the atmosphere.

The agitator may be driven by a dedicated motor, typically located on the floor tool. Power and signals may be provided between the main body and this dedicated motor by means of electrical connections. Conventionally, this is effected by means of wires running inside, or alongside, the hose and wand assembly.

A problem which may be encountered with hoses for surface treating appliances is that, in use, the hose twists and has a tendency to kink. This can be annoying to the user, as well as causing damage to the hose. This is a particular problem when electrical wires run down or alongside the hose, as kinking can cause damage to the wires.

### SUMMARY OF THE INVENTION

A first aspect of the invention provides a hose assembly for a surface treating appliance comprising first and second hose portions having respective electrical conductors and a joint between the hose portions arranged to permit relative rotational movement of the hose portions, the conductor of one hose portion being in sliding intimate contact with the conductor of the other hose portion.

The provision of a joint permits rotation of the hose portions so that kinking is reduced. The sliding contact of one conductor with another allows the hose portions to rotate freely without interruption of electrical power or signals.

The invention is suitable for hose assemblies in which electrical conductors run inside, or alongside, the hose. In such an application, the hose portions include at least one electrical conductor and the joint comprises a slip ring arrangement arranged to provide an electrical connection between the conductors in the respective hose portions.

Preferably, a plurality of conductors is provided in each hose portion, the conductors of one hose portion being in sliding intimate contact with the respective conductors of the other hose portion. Advantageously, this is effected by means of a slip ring arrangement, with conductors of one hose portion contacting slip rings on the other hose portion.

The term “surface treating appliance” is intended to have a broad meaning, and includes a wide range of machines having a head for travelling over a surface to clean or treat the surface in some manner. It includes, inter alia, machines which apply suction to the surface so as to draw material from it, such as vacuum cleaners (dry, wet and wet/dry), as well as machines which apply material to the surface, such as polishing/waxing machines, pressure washing machines, ground marking machines and shampooing machines. It also includes lawn mowers and other cutting machines.

### BRIEF DESCRIPTION OF THE DRAWINGS

The invention will now be described, by way of example, with reference to the accompanying drawings, in which:

FIGS. 1a and 1b are exploded views of components of a hose assembly constructed according to the invention;

FIG. 2 is a partly cut-away perspective view of part of the hose assembly of FIG. 1;

FIG. 3 is a partly cross-sectional view along the line A-A′ of FIG. 2;

FIG. 4 is a partly sectional view of a hose and wand assembly, incorporating the hose of FIGS. 1 to 3, in a retracted position;

FIG. 5 is a partly sectional view of the hose and wand assembly of FIG. 4 in an extended position;

FIG. 6 illustrates a vacuum cleaner incorporating the hose and wand assembly of FIGS. 4 and 5, with the wand in a retracted position;

FIG. 7 illustrates the vacuum cleaner of FIG. 6 with the wand in an extended position; and

FIG. 8 illustrates the vacuum cleaner of FIGS. 6 and 7 in use.

### DETAILED DESCRIPTION OF THE INVENTION

Like reference numerals refer to like parts throughout the specification.

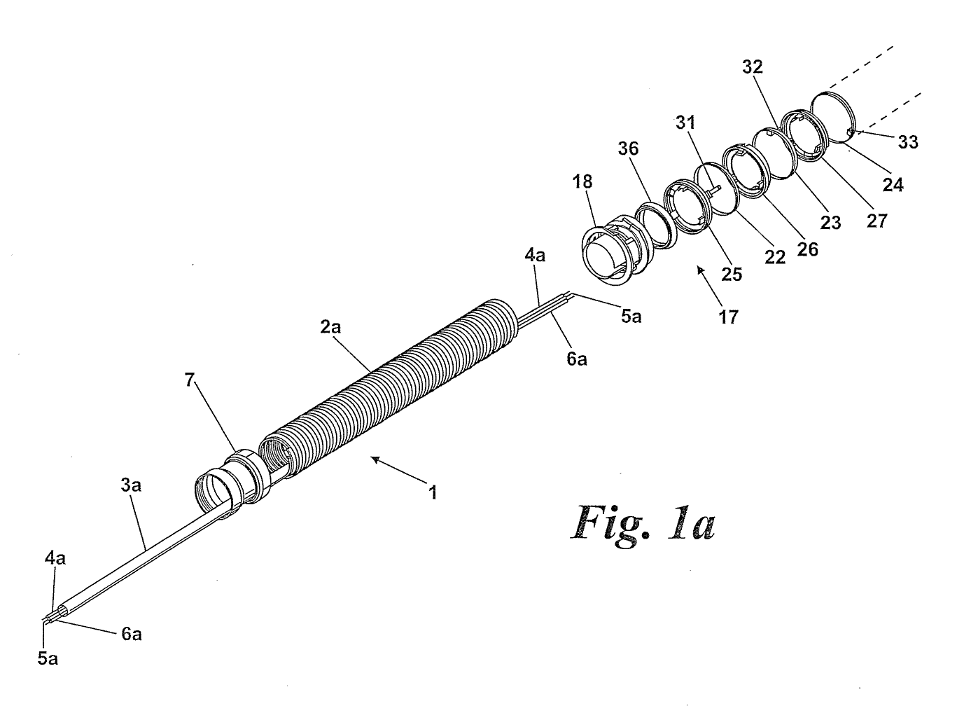

FIGS. 1a and 1b collectively illustrate components of the hose assembly, generally indicated by the reference numeral 1. In this embodiment, he hose assembly comprises a pair of hose portions 2a, 2b, although more portions may be provided. Only short sections of the hose portions 2a, 2b are shown in these drawings for clarity. Typically, the hose portions 2a, 2b would be much longer. Each hose portion 2a, 2b comprises a tube of corrugated plastics material, which is flexible and strong, and may be stretched. The hose portions 2a, 2b together form a fluid flow conduit.

Running along the interior of each hose portion 2a, 2b is a sleeve 3a, 3b respectively. The sleeves 3a, 3b are of relatively small diameter compared with the diameter of the hose portions 2a, 2b. The sleeves 3a, 3b are affixed to the inner walls of the hose portions 2a, 2b, such that each sleeve lies substantially parallel to the longitudinal axis of the hose portion to which it is affixed. The sleeves 3a, 3b may be glued to the hose portions 2a, 2b, heat-welded to them, or affixed by any other suitable means.

Each sleeve 3a, 3b is arranged to provide a protective housing for electrical conductors running along the sleeves. In this embodiment, three electrical conductors 4 (4a and 4b), 5 (5a and 5b) and 6 (6a and 6b) are provided, in order to permit transmission of power and signals along the hose assembly 1. Conductors 4a, 5a and 6a are located inside sleeve 3a and conductors 4b, 5b and 6b run inside sleeve 3b. The conductors 4, 5, 6 are electrically insulated from each other by means of plastic sheaths.

A wand connector 7 at one end of the hose portion 2a permits the hose assembly 1 to be connected to a wand, which shall be described later in the specification. The sleeve 3a sheathing the conductors 4a, 5a, 6a, extends beyond the wand connector 7.

At the opposite end of the other hose portion 2b, there is provided a main body connector 8, which permits the hose to be connected to the main body of an appliance, such as a vacuum cleaner. The connector 8 carries an electrical connector block 9. The ends of the conductors 4, 5, 6 terminate in apertures 10, 11, 12 in an end face of the connector block 9. The other end face carries pins 13, 14, 15, which connect electrically to the conductors 4, 5, 6 inside the block. The pins 13, 14, 15 provide a male connector for inserting into an appropriate female connector on the main body of the appliance. A cover 16 fits over the connector 8 and connector block 9, to protect the electrical connections from damage or tampering.

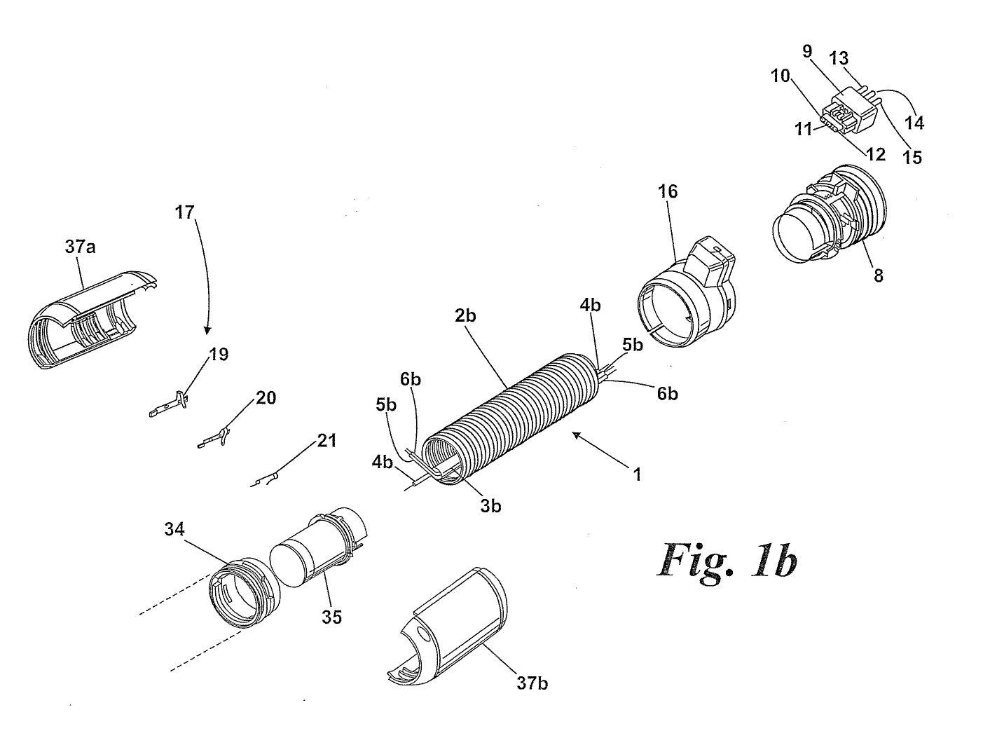

In accordance with the invention, a joint 17 is provided between the hose portions 2a, 2b. Part of the joint 17 is shown in FIG. 1a, and part in FIG. 1b. The joint 17 permits the hose portion 2b to swivel with respect to the hose portion 2a. A first cuff 18, attached to the hose portion 2a, provides a termination for the conductors 4a, 5a and 6a. The ends of conductors 4a, 5a and 6a are electrically connected to contact arms 19, 20, 21. The electrical connection may be effected by crimping the ends of the conductors to the arms, soldering them, or any other suitable technique. The contact aims 19, 20, 21 are staggered in position both radially and axially along the cuff 18. The arrangement of contact arms 19, 20, 21 is more clearly visible in FIG. 2, which shows the components of the joint 17 as assembled. The cuff 18 and contact arms 19, 20, 21 are arranged to remain stationary with respect to the hose portion 2a.

The joint 17 further comprises three slip rings, 22, 23, 24, which are electrically conductive. The slip rings 22, 23, 24 are supported by support rings 25, 26, 27, which also serve to space the slip rings from each other. When the joint 17 is assembled, as can be seen in FIG. 2, the contact arm 19 contacts the slip ring 22, the arm 20 contacts the ring 23 and the arm 21 contacts the ring 24. In this manner, electrical contact between the conductors 4a, 5a and 6a, and the rings 22, 23 and 24 respectively is established.

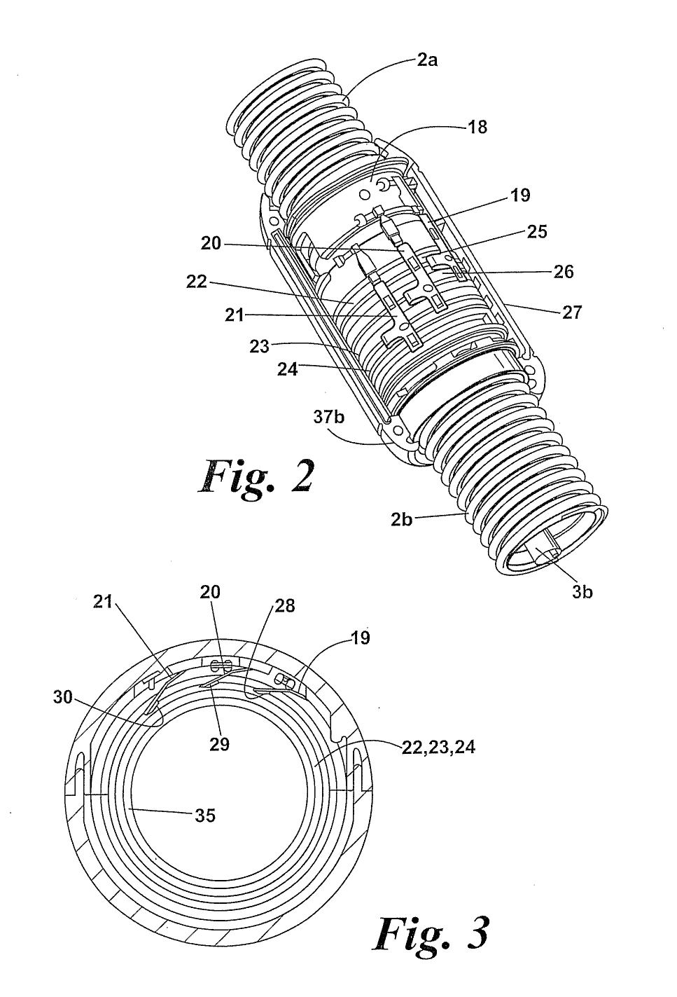

FIG. 3 is a partly sectional view along the line A-A′ of FIG. 2, showing the contact made between the arms 19, 20, 21 and the slip ring arrangement. Each of the contact arms 19, 20, 21 is resiliently biased radially inwards. In this embodiment, this is achieved simply by bending the metal connector arms 19, 20, 21 radially inwards. Other biasing means, such as springs may be provided. The underside of each connector arm 19, 20, 21 carries a metal pad 28, 29, 30 respectively. The metal pads 28, 29, 30 are urged against the slip rings 22, 23, 24 respectively. The metal pads 28, 29, 30 each have a rounded profile to permit the slip rings 22, 23, 24 to move slidably with respect to the connector arms 19, 20, 21 in both clockwise and anticlockwise directions. Thus, the slip ring arrangement can swivel with respect to the hose portion 2a. In this manner, the joint 17 permits relative rotational movement between the hose portions 2a and 2b

The inner wall of the slip ring 22 carries a long metal tab 31 that extends axially under the support rings 26 and 27. The inner wall of the slip ring 23 carries a medium length metal tab 32 that extends parallel to the tab 31 under the support ring 27. The inner wall of the slip ring 24 carries a short metal tab 33 that also extends axially in the same direction as tabs 31 and 32. The three tabs 31, 32, 33 terminate at a second cuff 34, located at the opposite end portion of the joint 17 from the first cuff 18. The second cuff 34 is connected to the second portion 2b of the hose and provides an electrical connection between the tabs 31, 32, 33 and the conductors 4b, 5b, 6b associated with this hose portion 2b. The electrical connection may be effected by crimping the conductors to the tabs, soldering them together, or any other suitable method. Thus, an electrical connection is made between the conductors 4a, 5a, 6a and the conductors 4b, 5b, 6b respectively.

A conduit 35 is attached to the hose portion 2b and extends axially under the arrangement of slip rings 22, 23, 24 and support rings 25, 26, 27. The conduit 35 terminates in a seal 36, which abuts the first cuff 18. The conduit 35 is arranged to rotate with the slip ring arrangement and so swivels with respect to the cuff 18. The conduit 35 provides a fluid flow path between the two portions 2a, 2b of the hose.

Finally, a cover 37 comprising two cover members 37a, 37b is provided in order to cover and protect the electrical connections of the joint 17 and to hold together the components.

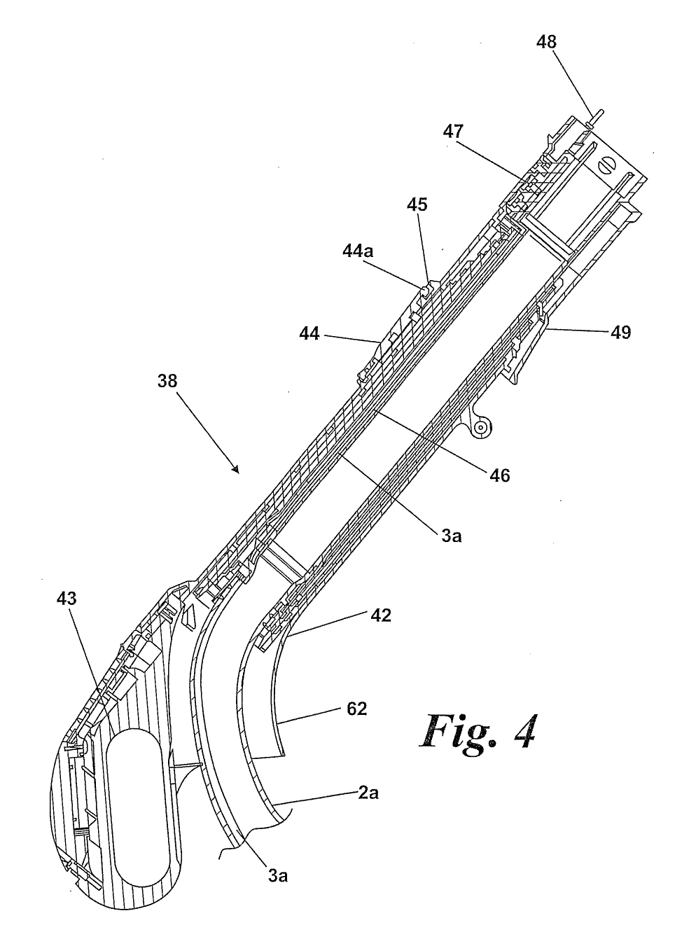

The cover 37 also serves another purpose when employed with a wand and hose assembly constructed according to the second aspect of the invention, such as is illustrated in FIGS. 4 to 8.

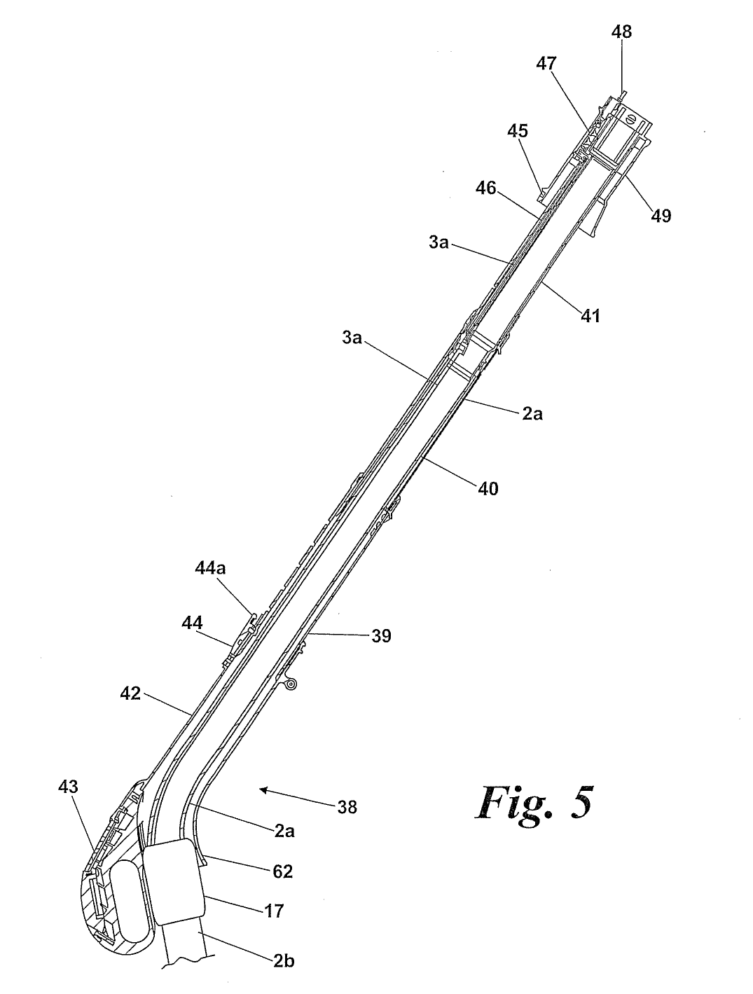

With reference to FIGS. 4 and 5, the wand assembly is indicated generally by the reference numeral 38. For clarity in these drawings, the hose portions 2a and 2b of the hose assembly 1 are shown without their corrugations. The wand assembly 38 comprises three separate tubes 39, 40, 41 of progressively decreasing diameter such that they can telescope inside one another. The three tubes 39, 40, 41 are retractably housed in a storage tube 42. A handle 43 is provided on the storage tube 42 to allow a user to manipulate the wand assembly 38.

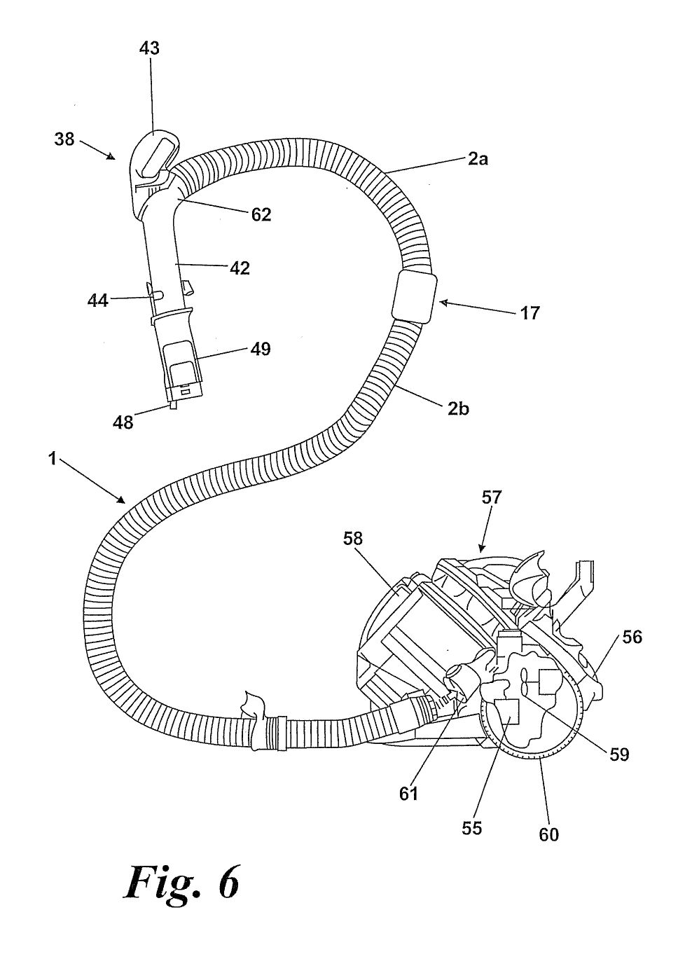

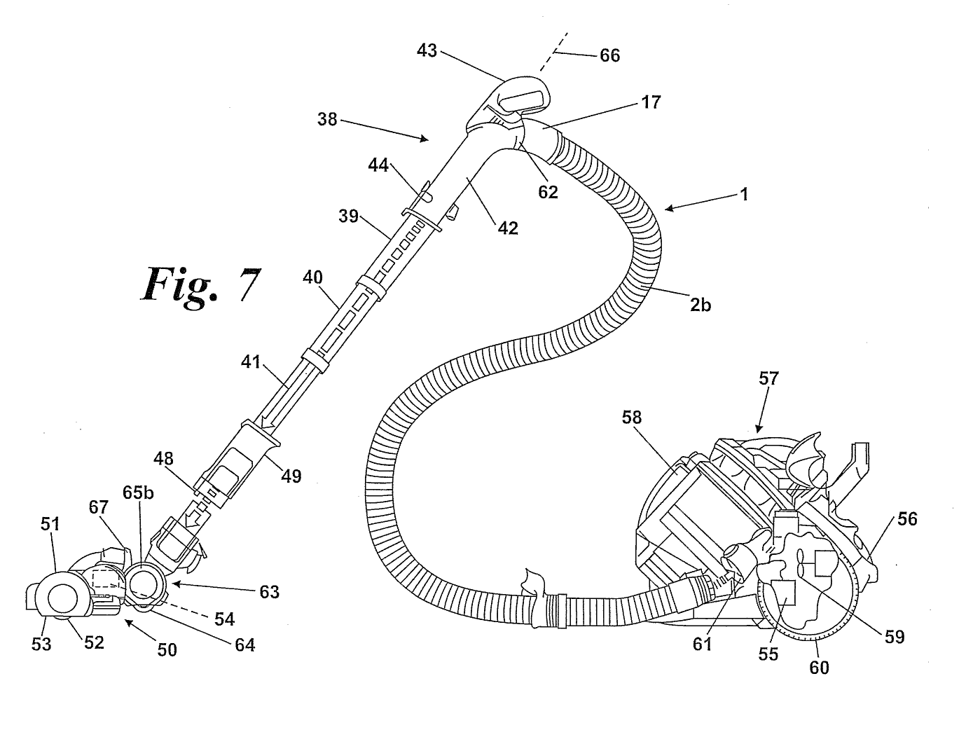

The tubes 39, 40, 41 are slidable inside one another and can be moved between a retracted position (as shown in FIGS. 4 and 6) and an extended position (as shown in FIGS. 5 and 7). In the fully extended position, only the ends of the tubes 39, 40, 41 overlap one another. In the fully retracted position, the tubes 39, 40, 41 fit inside one another and occupy the storage tube 42.

A locking lever 44 is provided on the storage tube 42. Locking lever 44 carries a hook 44a which sits in a notch 45 on the distal end of the smallest tube 41 when the wand assembly 38 occupies the retracted position. The hook 44a and notch 45 arrangement securely hold the tubes 39, 40, 41 inside the storage tube 42 until the locking lever 44 is operated to release the hook 44a.

The mechanisms by which the tubes may be extended and retracted are not the subject of this patent application, and so will not be described in detail. A suitable arrangement of securing mechanisms that permit the tubes to move slidably with respect to each other and to lock in the extended position is described in our patent EP1365676. One of the advantages of employing such a wand arrangement is that complete extension and retraction of the wand can be performed in one continuous, swift movement without the need for a user separately to operate each securing mechanism.

The hose 2 is connected to tube 41 such that, when the tubes 39, 40, 41 occupy the extended position, the hose portion 2a, which incorporates the electrical conductors 4a, 5a and 6a, extends along the interior of the wand assembly 38. Thus, a continuous electrical connection is made across the telescoping parts of the wand assembly in a straightforward manner. As a further benefit, the provision of the hose extending along the interior of the wand obviates the need for reliable sealing connections between the tubes of the wand.

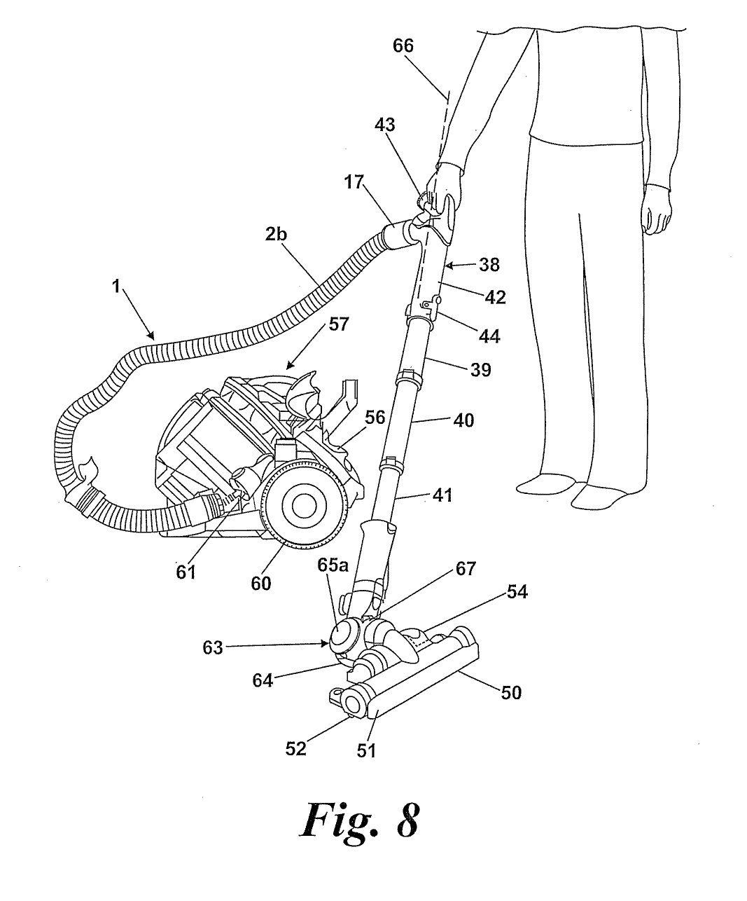

The wand connector 7 on hose portion 2a is secured to an end of the tube 41 of smallest diameter. In this embodiment the wand connector 7 is attached to the proximate end of tube 41, viz the end that is nearer the tube 40, rather than the distal end of the tube 41. This is because the hose 2 need not extend beyond the connection between the tubes 40 and 41, as there are no further sliding or movable wand parts beyond this point. The sleeve 3a extends inside a channel 46 running along the inner wall of the tube 41. A wand connector block 47 on the distal end of the tube 41 provides an electrical connection between the conductors 4a, 5a, 6a and corresponding pins 48 protruding from the end of the wand assembly 38. The wand connector block 46 is incorporated in a flared cuff 49 at the distal end of the tube 41. The pins 48 form a male connector for connecting with, for example, a floor tool 50, which is shown in FIGS. 7 and 8.

The floor tool 50 comprises a housing 51 with a chamber for supporting an agitator in the form of a brush bar 52. The lower, floor-facing side of the chamber has an air inlet slot 53 and the brush bar 52 is rotatably mounted in the chamber such that bristles on the brush bar can protrude through the inlet slot and can agitate the floor surface over which the surface treating head passes. The brush bar 52 is rotatably driven by a dedicated motor 54 positioned on the rear of the housing 51.

The electrical conductors 4, 5, 6, which extend along the length of the hose and, consequently, the wand assembly in its extended position, provide power to the motor 54 and can also transmit signals between switches or other components on the floor tool 50 and an electronic processor 55, which, in this embodiment of the invention, is conveniently located on the main body 56 of a surface-treating appliance in the form of a vacuum cleaner 57.

The main body 56 of the vacuum cleaner 57 houses separating apparatus 58 and a motor-driven fan 59 for generating a suction airflow which can draw dirt-laden air into the separating apparatus. In this embodiment, the separating apparatus 58 comprises cyclonic separators which spin dirt, dust and debris from the airflow. Other forms of separator, such as a filter bag, an electrostatic separator or a liquid-based separator may be employed. The form of the separating apparatus 58 is not material to the invention. The main body 56 also has wheels 60 which allow the main body 56 to be pulled along a surface to be treated.

The connector 8 of the hose assembly 1 is connectable to the main body 56 by means of an inlet 61 on the main body 56. The main body 56 of the cleaner 57 may pulled along by the hose as a user moves around a room. The hose has a construction which is robust enough to withstand this pulling action, and any normal abrasion which may be encountered as the hose rubs against obstacles in a room. The pins 13, 14, 15 protruding from the connector 8 make electrical contact with a corresponding female connector (not visible in these drawings) in the inlet 61. Electrical connections inside the main body 56 connect the conductors in the hose to the electronic processor 55.

The electronic processor 55 may be arranged to perform a variety of functions. For example, the power transmitted to the agitator motor 54 may be regulated in dependence on the type of surface being treated. The processor 55 may be arranged to monitor the state of switches associated with the floor tool and the vacuum cleaner, in order to de-energise the agitator motor 54 or the main motor if the floor tool 50 or the cleaner 57 malfunctions or is being misused. The processor may also be arranged to record usage of the cleaner 57 and/or the floor tool 50 for diagnostic or research purposes. Data may be uploaded to the processor 55 in order to modify certain operating parameters of the appliance, for example the operating temperature at which the main motor de-energises.

In order to use the vacuum cleaner 57 and floor tool 50 for a cleaning operation, the user must extend the tubes 39, 40, 41 of the wand assembly 38 from the retracted position of FIG. 6 to the extended position of FIG. 7. In doing do, the hose 2 slides along the interior of the wand assembly 38 as previously described. During this movement, the joint 17 moves towards the wand assembly 38. When the wand assembly occupies the fully extended position of FIG. 7, the cover 37 of the joint 17 abuts the end of the storage tube 42. The end of the storage tube 42 may have a flared opening 62, to accommodate the rounded contours of the end of the cover 37. The cover 37 permits the hose 2 to swivel with respect to the wand assembly 38 and protects it from the wear and tear it might otherwise experience from being in close moving contact with the opening 62 of the storage tube 42. Furthermore, location of the joint 17 proximate the wand assembly 38 is a comfortable position for the user.

FIG. 8 shows the vacuum cleaner 57 and floor tool 50 in use. The floor tool further comprises a rolling support assembly 63 arranged to roll with respect to the housing 51, and which permits the head to be manoeuvred along a floor surface. The rolling support assembly 63 comprises a central roller 64 and a pair of outer rollers 65a, 65b, which are arranged relative to each other so as to provide a rolling support surface. In use, the user rotates the wand assembly 38 about its longitudinal axis 66 by means of the handle 42. This causes an axis of the rolling support assembly 63 to tilt with respect to the floor. A rotatable joint 67 located between the housing 51 and the rolling support assembly 63 permits the housing of the tool 50 to turn whilst remaining in contact with the floor. The extent to which the wand assembly 38 about the longitudinal axis 66 determines the extent to which the tool 50 moves from its forward facing position towards the right or left.

Variations may be made without departing from the scope of the invention. For example, the electrically conductive parts of the joint 17 may be arranged so that the slip rings remain stationary while the contact arms—and, consequently, the hose portion to which those arms are attached—are allowed to slide around the outer diameter of each slip ring. The contact arms may be arranged to contact the inner surface of the, or each, slip ring.

The invention has been described in relation to a joint in which one hose portion is affixed to a wand assembly, and so remains stationary, whilst the other hose portion is rotatable relative to it. The joint may alternatively be arranged so that both hose portions are able to move independently of each other.

The joint may be arranged to give relative swivelling movement over a predetermined range of angles, with stops preventing rotational movement beyond a predetermined point.

The invention has been described in a relation to a hose comprising two hose portions with one joint therebetween. Further hose portions, and joints between each portion, may be provided.

The hose and wand assembly may include more or fewer conductors and more or fewer tubes. Not all of the tubes of the wand assembly need be capable of telescopic movement relative to other tubes. The sleeve extending down the hose may be arranged to enclose other components. A further sleeve may be provided as a further fluid conduit arranged to allow, for example, water or cleaning fluid to flow along the wand and hose.

1. A hose assembly for a surface treating appliance comprising first and second hose portions having respective electrical conductors and a joint between the hose portions arranged to permit relative rotational movement of the hose portions, the conductor of one hose portion being in sliding intimate contact with the conductor of the other hose portion.

2. The assembly of claim 1, in which the joint comprises a slip ring arrangement arranged to provide a sliding electrical connection between the conductors in the respective hose portions.

3. The assembly of claim 2, in which the conductor of one of the first and second hose portions is arranged to electrically contact the slip ring arrangement so as to permit relative rotational movement between the conductor and the slip ring arrangement.

4. The assembly of claim 1, in which the hose portions include a plurality of conductors and the joint comprises a plurality of slip rings arranged to connect respective ones of the conductors of the first hose portion to corresponding conductors of the second hose portion.

5. The assembly of claim 4, in which the conductors of one of the first and second hose portions are arranged to electrically contact respective slip rings so as to permit relative rotational movement between the conductors and the slip rings.

6. The assembly of claim 2, in which each conductor is carried by a sleeve in the hose portion.

7. The assembly of claim 6, in which the sleeve is attached to an inner wall of the hose portion.

8. The assembly of claim 1, further comprising a connector at one end portion of one of the first and second hose portions arranged to permit physical and electrical connection to a surface treating appliance.

9. The assembly of claim 1, further comprising a connector at one end portion of one of the first and second hose portions arranged to permit physical and electrical connection to a wand assembly of a surface treating appliance.

10. The assembly of claim 1, further comprising a cover for the joint.

11. (canceled)

12. A wand assembly including the hose assembly of claim 1.

13. A surface treating appliance including the hose assembly of claim 1.

14. The appliance of claim 13, further comprising a processor arranged to transmit power to the hose.

15. The appliance of claim 13, further comprising a processor arranged to transmit signals to the hose.

16. The appliance of claim 13, further comprising a processor arranged to receive signals from the hose.

17. The appliance of claim 13, further comprising a floor tool having a motor-driven agitator.

18. (canceled)

19. A vacuum cleaner comprising the surface treating appliance of claim 13.
